(19) United States
(12) Patent Application Publication
(10) Pub. No.: US 2016/0200505 A1
(43) Pub. Date: Jul. 14, 2016

(54) REFRIGERATED CONTAINER ASSEMBLY

(71) Applicant: CARRIER CORPORATION, Farmington, CT (US)

(72) Inventors: Dennis M. Stone, Cicero, NY (US); Ping Sue Vang, Liverpool, NY (US); Mingfei Gan, Manlius, NY (US); Kenneth Cresswell, Cazenovia, NY (US)

(21) Appl. No.: 14/916,804

(22) PCT Filed: Jul. 1, 2014
(86) PCT No.: PCT/US2014/044983

§ 371 Date: Mar. 4, 2016

Related U.S. Application Data
(60) Provisional application No. 61/875,794, filed on Sep. 10, 2013.

(51) Int. Cl. B65D 88/74; B23P 19/00

(52) U.S. Cl. CPC B65D 88/745; B23P 19/00

(57) ABSTRACT

A refrigerated transportation cargo container includes a transportation cargo container and a refrigeration unit located at an end of the transportation cargo container to provide a flow of supply air for the transportation cargo container. The refrigeration unit includes a housing having a front wall with one or more front wall openings therein. A back wall is located opposite the front wall and nearer to an interior of the cargo container relative to the front wall. One or more components of a refrigeration unit are installed in the housing via insertion through the one or more front wall openings.

### BACKGROUND OF THE INVENTION

The subject matter disclosed herein relates to refrigeration systems. More specifically, the subject matter disclosed herein relates to refrigeration of containers utilized to store and ship cargo.

A typical refrigerated cargo container, such as those utilized to transport a cargo via sea, rail or road, is a container modified to include a refrigeration unit located at one end of the container. The refrigeration unit includes a compressor, condenser, expansion valve and evaporator coil, all located at the end of the container. A volume of refrigerant circulates throughout the refrigeration unit, and one or more evaporator fans of the refrigeration unit blow a flow of supply air across the evaporator coil cooling the supply air and forcing it out into the container.

Typically, installation and service of the evaporator fans and evaporator coil, or “evaporator section” of the refrigeration unit is performed from an interior of the cargo container. The evaporator section is a large component, often installed and removed with the assistance of a fork lift or other similar installation device. Use of such equipment in the interior of the cargo container risks damage to the interior walls and/or floor of the cargo container and other components of the refrigeration system. Further, such installation and service requires movement of technicians into and out of the cargo container, some of which are 50 feet in length. Such movement is inefficient and increases installation and/or service time.

### BRIEF DESCRIPTION OF THE INVENTION

In one embodiment, a refrigerated transportation cargo container includes a transportation cargo container and a refrigeration unit located at an end of the transportation cargo container to provide a flow of supply air for the transportation cargo container. The refrigeration unit includes a housing having a front wall with one or more front wall openings therein. A back wall is located opposite the front wall and nearer to an interior of the cargo container relative to the front wall. One or more components of a refrigeration unit are installed in the housing via insertion through the one or more front wall openings.

In another embodiment, a method of assembling a refrigerated transportation cargo container includes installing one or more components of a refrigeration unit into a housing. The housing has a back wall and a front wall opposite the back wall. The installation of the one or more components is accomplished by inserting the one or more components into the housing through one or more front wall openings. The housing is installed to a cargo container with the back wall of the housing closest to an interior of the cargo container, relative to the front wall of the housing.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an embodiment of a refrigerated transportation cargo container;

FIG. 2 is a schematic illustration of an embodiment of a refrigeration unit for a refrigerated transportation cargo container;

FIG. 3 is another schematic illustration of an embodiment of installation of a refrigeration unit into a refrigerated transportation cargo container; and

FIG. 4 is a schematic illustration of another embodiment of installation of a refrigeration unit into a refrigerated transportation cargo container.

The detailed description explains embodiments of the invention, together with advantages and features, by way of example with reference to the drawing.

### DETAILED DESCRIPTION OF THE INVENTION

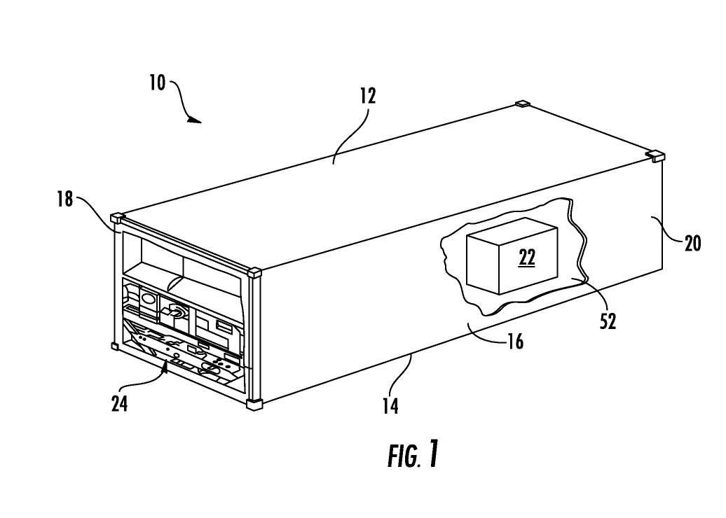

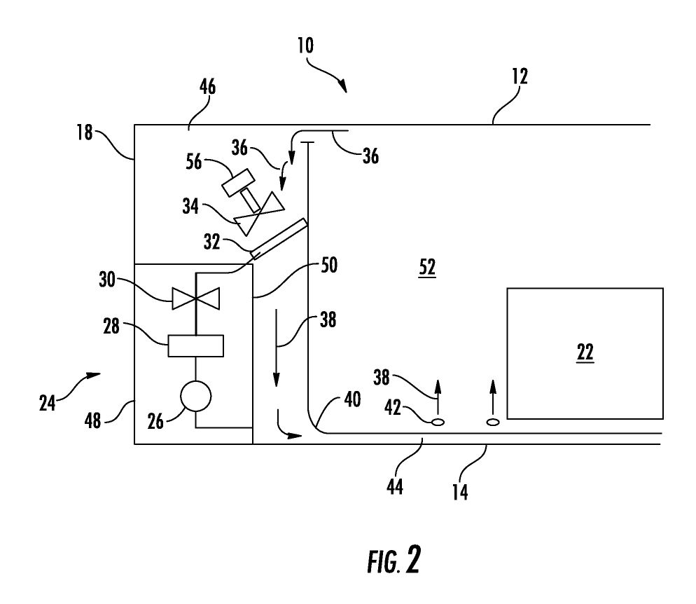

Shown in FIG. 1 is an embodiment of a refrigerated cargo container 10. The cargo container 10 is formed into a generally rectangular construction, with a top wall 12, a directly opposed bottom wall 14, opposed side walls 16 and a front wall 18. The cargo container 10 further includes a door or doors (not shown) at a rear wall 20, opposite the front wall 18. The cargo container 10 is configured to maintain a cargo 22 located inside the cargo container 10 at a selected temperature through the use of a refrigeration unit 24 located at the container 10. The cargo container 10 is mobile and is utilized to transport the cargo 22 via, for example, a truck, a train or a ship. The refrigeration unit 24 is located at the front wall 18, and includes a compressor 26, a condenser 28, an expansion valve 30, an evaporator 32 and an evaporator fan 34 (shown in FIG. 2), as well as other ancillary components.

Referring to FIG. 2, the refrigeration unit 24 flows return airflow 36 across the evaporator 32 via the evaporator fan 34, thus cooling the airflow 36 to a selected temperature and urges the cooled return airflow 36, now referred to as supply air 38, through a refrigeration unit outlet 40 into the container 10 via, for example, openings 42 in one or more T-bars 44 extending along the bottom wall 14 of the container 10 to cool the cargo 22.

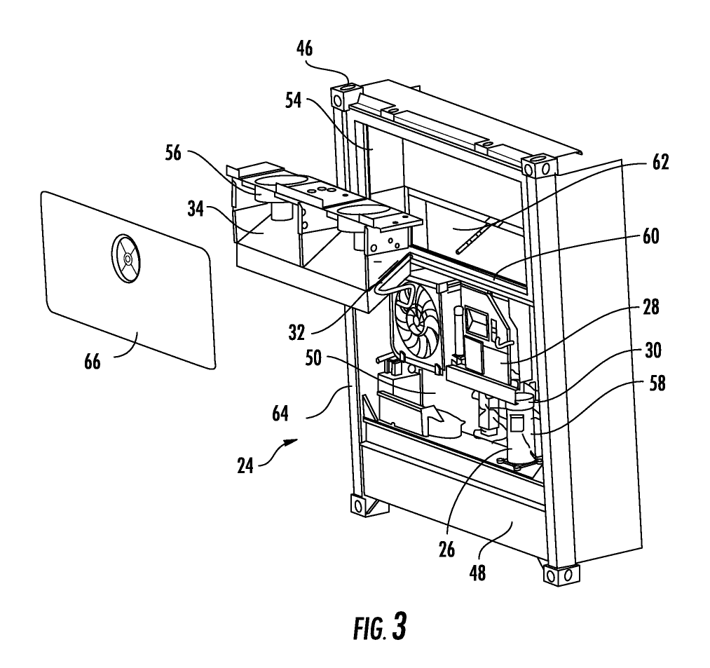

Referring now to FIG. 3, the refrigeration unit 24 includes a housing 46 to contain components of the refrigeration unit 24. The housing 46 includes a front panel 48 and a back panel 50 opposite the front panel 48 and nearer to an interior 52 of the cargo container 10.

In some embodiments, the housing 46 is separate and distinct from the cargo container 10, while in other embodiments, the housing 46 is an integral part of the cargo container 10. In some embodiments, the housing 46 is separated into an evaporator section 54 containing the evaporator 32, the evaporator fan 34 and an evaporator fan motor 56 and a condenser section 58 containing the compressor 26, the condenser 28 and the expansion valve 30. The evaporator section 54, located above the condenser section 58 in some embodiments, is separated from the condenser section 58 by an evaporator support 60 extending across the housing 46.

The back panel 50 is configured as a structural member such that the components of the refrigeration unit 24, including the evaporator 32, the evaporator fan 34, the evaporator fan motor 56, the compressor 26, the condenser 28 and/or the expansion valve 30, are secured to and/or supported by the back panel 50. The front panel 48 of the housing 46 is configured with front panel openings 62 and 64. The front panel opening 62 allows for installation and/or removal of the components in the evaporator section 54 therethrough, and the front panel opening 64 allows for installation and/or removal of the components on the condenser section 58 therethrough. The front panel openings 62 and 64 allow for installation, removal and service of the components from outside of the cargo container 10, thus reducing installation and/or service time. Servicing the condenser section 58 and the evaporator section 54 from the outside of the cargo container 10 via the front panel openings 62 and 64 allows such servicing to be performed while the cargo container 10 is fully loaded with cargo 22, thereby saving servicing time since the container 10 does not need to be unloaded first.

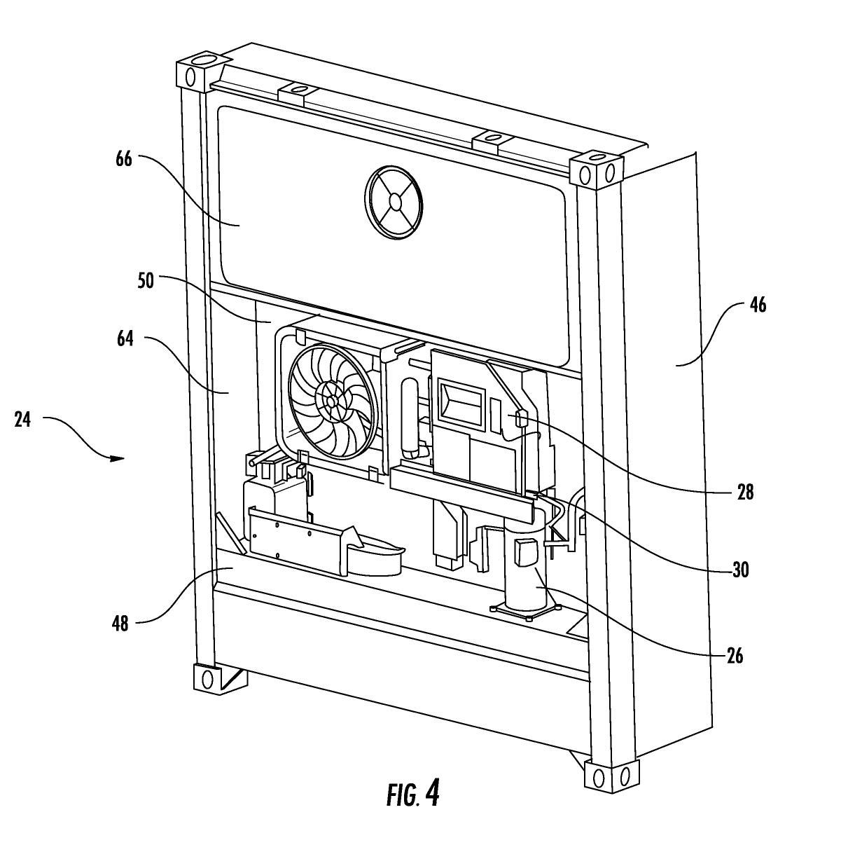

Referring to FIG. 4, one or more covers 66 are used to cover the front panel openings 62 and 64, and are removed to provide access to the evaporator section 54 and the condenser section 58. In some embodiments, the covers 66 are attached via hinges (not shown) to the housing 46. Further, the covers 66 are, in some embodiments, insulated to minimize losses through the covers 66.

In one embodiment, assembly of the cargo container 10 is accomplished by installing the housing 46 to the cargo container 10 through front panel openings 62 and/or 64, then installing the refrigeration unit 24 components (the evaporator 32, evaporator fan 34, evaporator fan motor 56, the compressor 26, the condenser 28 and the expansion valve 30) to the housing 46 through the front panel openings 62 and/or 64. In other embodiments, the refrigeration unit 24 components are installed to the housing 46, then the housing 46 is installed to the cargo container 10 through the front panel openings 62 and/or 64.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A refrigerated transportation cargo container comprising:
a transportation cargo container;
a refrigeration unit disposed at an end of the transportation cargo container to provide a flow of supply air for the transportation cargo container, the refrigeration unit including:
a housing having:
a front wall having one or more front wall openings therein;
a back wall disposed opposite the front wall and nearer to an interior of the cargo container relative to the front wall; and
one or more components of a refrigeration unit installed in the housing via insertion through the one or more front wall openings.

2. The refrigerated transportation cargo container of claim 1, further comprising one or more covers over the one or more front wall openings.

3. The refrigerated transportation cargo container of claim 1, wherein the one or more components include an evaporator, a condenser and/or compressor.

4. The refrigerated transportation cargo container of claim 1, wherein the one or more components are supported by the back wall.

5. The refrigerated transport cargo container of claim 1, wherein the one or more components are secured to the back wall.

6. The refrigerated transportation cargo container of claim 1, wherein the housing is divided into two or more compartments.

7. A method of assembling a refrigerated transportation cargo container comprising:
installing one or more components of a refrigeration unit into a housing, the housing having a back wall and a front wall opposite the back wall, the installing of the one or more components by inserting the one or more components into the housing through one or more front wall openings; and
installing the housing to a cargo container with the back wall of the housing closest to an interior of the cargo container, relative to the front wall of the housing.

8. The method of claim 7, further comprising installing one or more covers over the one or more front wall openings.

9. The method of claim 7, wherein the one or more components include an evaporator, a condenser and/or compressor.

10. The method of claim 7, further comprising supporting the one or more components via the back wall.

11. The method of claim 7, further comprising securing the one or more to the back wall.

12. The method of claim 7, wherein the housing is divided into two or more compartments.

13. The method of claim 7, comprising installing the one or more components into the housing before installing the housing into the cargo container.

14. The method of claim 7, comprising installing the housing into the cargo container before installing the one or more components into the housing.

15. The method of claim 7, further comprising removing one or more components from the housing via the one or more front wall openings.

16. The method of claim 7, further comprising servicing one or more components via the one or more front wall openings.
